(19) United States
(12) Patent Application Publication
(10) Pub. No.: US 2005/0213590 A1
(43) Pub. Date: Sep. 29, 2005

(54) Universal telecommunication node with software-defined exchangeable protocol architecture

(75) Inventors: Markus Hauenstein, Dusseldorf (DE); Stephan Grunloh, Osnabruck (DE); Tamas Major, Dusseldorf (DE); Gerald Berghoff, Dusseldorf (DE); Martin Brundert, Dusseldorf (DE)

Correspondence Address: SQUIRE, SANDERS & DEMPSEY L.L.P.;14th Floor, 8000 Towers Crescent Drive, Tysons Corner, VA, 22182-2700, US

(73) Assignee: Nokia Corporation

(21) Appl. No.: 10/919,071

(22) Filed: Aug. 16, 2004

Related U.S. Application Data
(60) Provisional application No. 60/555,293, filed on Mar. 23, 2004.

(51) Int. Cl. H04L 12/28

(52) U.S. Cl. 370/401

(57) ABSTRACT

The invention proposes a network node comprising modules (1, 2, 3, 4, 6; 7) including transport functions in order to support a particular network transport protocol, wherein the transport functions are realized by software. The invention also proposes a method for operating the network node. Different network transport protocols are supported with the same hardware by installing corresponding software.

### REFERENCE TO RELATED APPLICATIONS

This application claims priority of U.S. Provisional Patent Application Ser. No. 60/555,293, filed on Mar. 23, 2004. The subject matter of this earlier filed provisional application is hereby incorporated by reference.

### BACKGROUND OF THE INVENTION

1. Field of the Invention

The invention relates to a network node and a method for operating a network node, wherein the network node comprises at least module.

2. Description of the Prior Art

In particular, the invention relates to a network node comprising at least module performing transport functions. An example for a network in which such a network node may be employed is a WDCMA (Wideband Code Division Multiple Access) Radio Access Network. Another example for such a network is a CDMA2000 network.

WDCMA Radio Access Networks (RAN) are specified by the 3^{rd} Generation Partnership Project (3GPP releases R99, R4 and R5).

FIG. 1 illustrates a Wideband-CDMA Radio Access Network and its interfaces This figure shows the general structure and context of WCDMA RANs. In particular, a WCDMA RAN comprises a plurality of base stations (BTS) and Radio Network Controller (RNC). A WCDMA Core Network (CN) comprises, for example, a Mobile Switching Center (MSC) and a Serving GPRS (General Packet Radio System) Support Node (SGSN).

The external interfaces are Iu, which is the interface to the WCDMA core network, and Uu. Uu is the ‘air interface’ to the user equipment (UE), i.e. the mobile phone with the UMTS (Universal Mobile Telecommunication Services) SIM (Subscriber Identity Module) card. The internal interfaces are defined as Iub between RNC and BTS and lur between RNCs.

The 3GPP protocol structure is based on the principle that the layers and planes are logically independent of each other. If needed, parts of the protocol structure may be changed in the future while other parts remain intact. The protocol structure consists of two main horizontal layers, the upper Radio Network Layer (RNL) and the lower Transport Network Layer (TNL). All WCDMA RAN-related issues are visible only at the Radio Network Layer, while the Transport Network Layer represents standard transport technology, which is selected for the WCDMA RAN but without WCDMA RAN-specific changes.

Initially, Asynchronous Transfer Mode (ATM) is used as transport protocol on the lub, i.e., the interface between BTS (also referred to as ‘node B’) and RNC, which is called more specifically Iub/ATM then.

This is illustrated in FIG. 2 which shows the protocol stack of the Iub/ATM interface. In particular, FIG. 2 depicts the protocol stack used at the lub interface in case of an ATM transport network. The two horizontal layers RNL and TNL are shown. From TNL point of view, RNL control plane (NBAP (Node B Application Part)) and RNL user plane (i.e. the frame protocols conveying the DCH (Dedicated Channel), RACH (Random Access Channel), FACH (Forward Access Channel )etc. data) are TNL user data. AAL2 (ATM Adaptation Layer 2) Signaling (Q.2630.1) is used for controlling the ATM-based TNL, i.e. AAL2 connections are setup and released according to the needs of the RNL. The signaling is transported via Signaling Transport Converter (STC) on SSCOP, SSCOP (Service specific connection oriented protocol) and AAL5, as illustrated in FIG. 2.

In addition, 3GPP Release R5 also specifies the Internet Protocol (IP) as an alternative transport protocol, which can be used instead of ATM. The interface between BTS and RNC is then called lub/IP.

This is illustrated in FIG. 3 showing the protocol stack of the lub/IP interface in case of an IP transport network. For the RNL, this is essentially the same as with ATM transport. Here, IPC (IP Control) signaling is used for controlling the IP-based TNL.

3GPP considers also IP because the general assumption is that substantial cost savings (OPEX (Operational Expenditure)) and CAPEX (Capital Expenditure)) can be achieved with IP in the future.

Typical BTS architectures reflect the separation of the lub into RNL and TNL layer: There is a transport block (TB), and there is radio network layer block, which may be further subdivided into baseband block (BB) and radio frequency block (RFB). With well-advised implementations, only the TB needs to be exchanged then when the transport protocol is changed from ATM to IP.

At hub sites aggregating traffic from several BTS, standard telecommunication nodes are typically deployed. In the ATM case, these are ATM cross-connects or switches, and in the IP case these are IP routers. Normally, an ATM node cannot be turned into an IP router, i.e. if a mobile operator eventually wants to change a hub point from ATM to IP transport, he will have to replace the ATM hardware by IP hardware. Therefore, at present ATM switch or cross-connect always remains an ATM switch or cross-connect, and an IP router always remains an IP router. The reason behind is specifically designed hardware (typically Application Specific Integrated Circuits (ASICs)), which supports only one transport protocol option.

In a typical WDCMA RAN, several thousands of base stations are deployed. If the lub/IP option becomes economically attractive in the future, a mobile operator might want to change some or all of the base stations in the WCDMA RAN from Iub/ATM to lub/IP then. Typically, there are also hub sites with ATM cross-connects or ATM switches, which need to be substituted by IP routers then. Such a migration from Iub/ATM to lub/IP is very expensive when major hardware changes are necessary.

### SUMMARY OF THE INVENTION

Hence, it is an object of the present invention to allow a change of transport protocol used for a network node with low cost and a minimum maintenance work.

This object is solved by a network node as defined in the independent claim 1.

Alternatively, the object is solved by a method for operating a network node as set out in the independent claim 13.

Thus, according to the invention the transport functions are realized by software. That is, if necessary, the software can easily be updated so that another transport protocol (e.g., ATM or IP) can be handled.

Hence, no exchange of hardware is necessary, so that costs and maintenance work required for the change of the transport protocol are minimal.

Further advantageous developments are set out in the dependent claims.

### BRIEF DESCRIPTION OF THE DRAWINGS

The invention is described in the following by referring to the attached drawings in which:

FIG. 1 shows a Wideband-CDMA Radio Access Network and its interfaces,

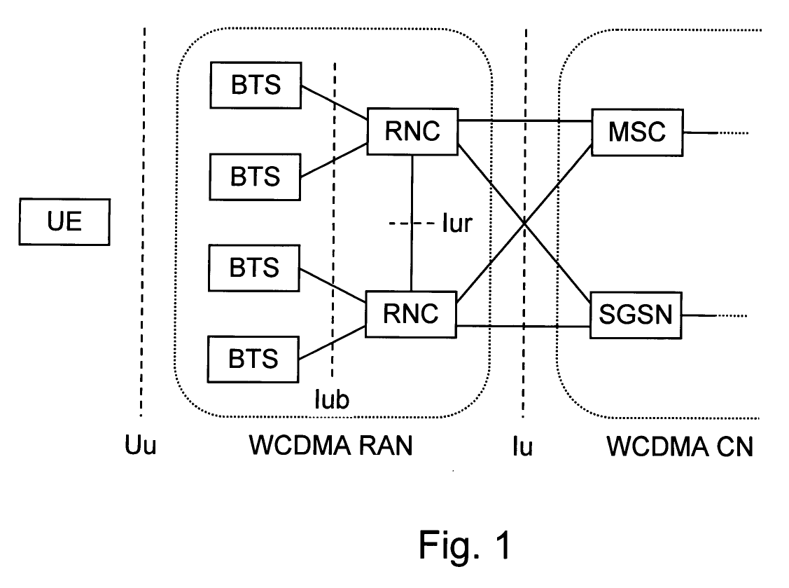

FIG. 2 shows a protocol stack of the Iub/ATM interface,

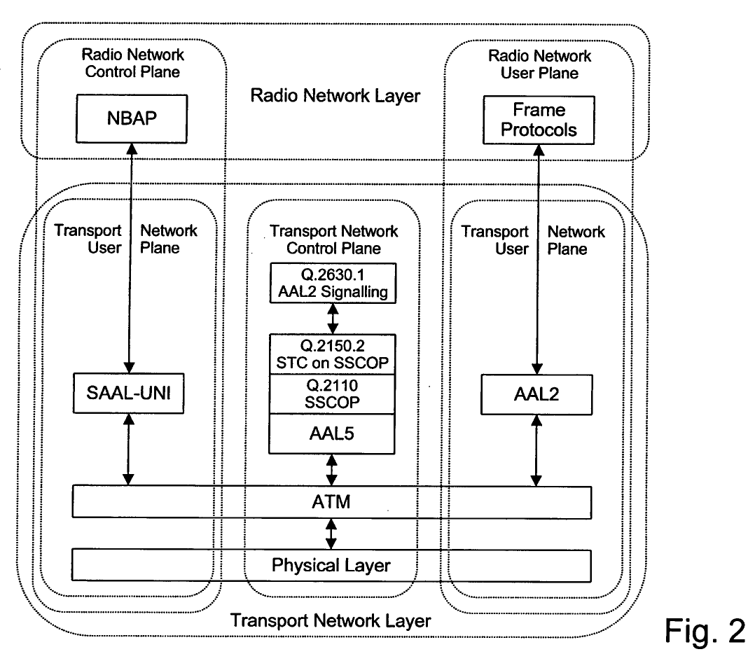

FIG. 3 shows a protocol of the lub/IP interface,

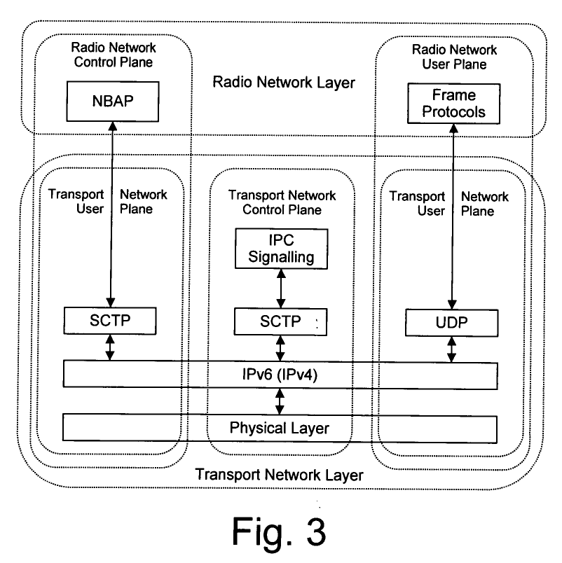

FIG. 4 shows a transport block with software-defined exchangeable protocol architecture according to a first preferred embodiment of the invention,

FIG. 5 shows a transport block with software-defined exchangeable transport protocol architecture customized for ATM according to the first embodiment of the invention,

FIG. 6 shows a transport block with software-defined exchangeable transport protocol architecture customized for IP according to the first embodiment of the invention, and

FIG. 7 shows a single module transport block according to a second preferred embodiment of the invention.

### DETAILED DESCRIPTION OF THE PREFERRED EMBODIMENTS

In the following, preferred embodiments of the invention are described.

In its general form, a network node according to the present embodiments of the invention comprises at least one module including transport functions in order to support a particular network transport protocol, wherein the transport functions are realized by software.

That is, according to the invention the transport functions are realized by software, whereas the rest of the module can be realized by hardware. This is, however, not limited thereon, parts of the rest of the module (in particular, control functions, for example) may also be realized by software.

Examples for the modules may be in particular interface modules which provides a connection to an external network. Another example is a central module, the transport functions of which provide a connection to higher layers of the network node, for example.

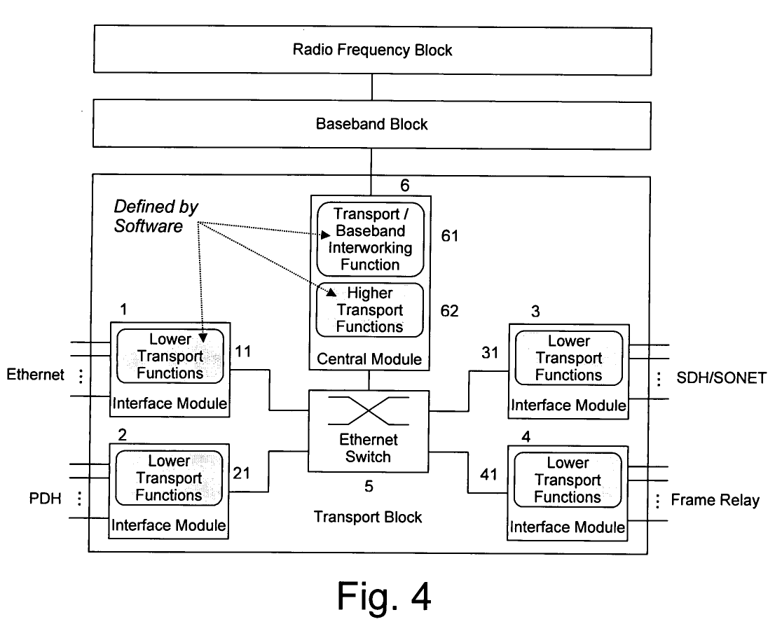

According to a specific example of the present embodiment described in the following, the network node is a base station, which comprises a transport block, a baseband block and a radio frequency block, as described in the following by referring to FIG. 4.

This base station can support both ATM and IP transport (3GPP Iub/ATM or lub/IP). Whether ATM or IP is used, is only determined by the embedded software of the transport block, and not by any hardware. This allows mobile operators in-field upgrade from ATM to IP via remote software change, without the need of very expensive site visits and hardware replacements.

The same idea can also be applied to standalone ATM nodes (e.g. deployed at hub sites). That is, by updating the software, the standalone ATM nodes can be transformed into IP routers by remote software change.

Furthermore, vendors of telecommunications equipment (e.g. base stations, ATM nodes or IP routers) can use exactly the same hardware platform for ATM and IP transport solutions by customizing the embedded software.

FIG. 4 shows a transport block with software-defined exchangeable transport protocol architecture. In particular, FIG. 4 shows a general model of a base station consisting of a transport block (TB), a baseband block (BB) and a radio frequency block (RFB). The transport block is depicted in more detail. As an example, four interface modules with different physical interface types are shown. The first interface module, denoted with reference numeral 1, provides an Ethernet interface. The second interface module 2 provides a PDH (Plesiochronous Digital Hierarchy) interface. The third interface module 3 provides a SDH/SONET (Synchronous Digital Hierarchy/Synchronous Optical Network) interface, and the fourth interface module 4 provides a Frame Relay interface. The interface modules handle lower transport functions, which are illustrated by the blocks 11, 21, 31 and 41 of the corresponding interface modules 1 to 4. They are specialized to the particular transport protocol (e.g. ATM or IP) by software.

A central module (depicted in the middle of the transport block) denoted with reference numeral 6 implements higher transport functions, illustrated by a block denoted with reference numeral 62, and the inter-working between transport and baseband block, which is illustrated by block 61. Also the higher transport layer and inter-working functions are realized in software; they can thus be adapted to the particular needs of the used transport protocol. All transport block modules (interface modules 1 to 4 and central module 6) are connected via an Ethernet switch 5 here. However, this is only an example for the present embodiment: Other—possibly proprietary—transport node-internal connection methods are also feasible. That is, for the switch some other kind of node-internal network providing means can be used, and instead of Ethernet another node-internal network transport protocol may be applied.

Thus, as shown in FIG. 4, the TB consists of a central module, which is supplemented by several interface modules. The interface modules implement lower transport layer (e.g. ATM layer or IP data link layer) and physical layer functions (e.g. PDH and SDH/SONET), and the central module implements higher transport layer functions (e.g. AAL2/AAL5 or IP routing). Furthermore, according to the present embodiment, the central module 6 also implements the necessary inter-working functions between the TB and the BB block. According to present embodiment, point-to-point VLAN (Virtual Local Area Network) Ethernet is used as universal transport mechanism inside the TB for connecting the interface modules to the central module.

All lower and higher transport layer functions (illustrated by the blocks 11, 21, 31, 41 and 62) and the inter-working function (illustrated by the block 61) are implemented in software on programmable high-performance processing engines, so that the complete transport layer and the inter-working function can be exchanged by installing new software.

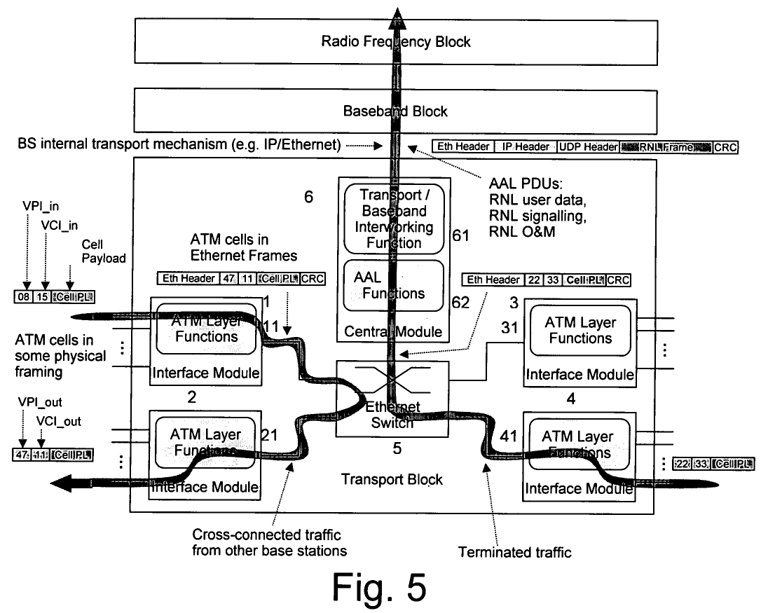

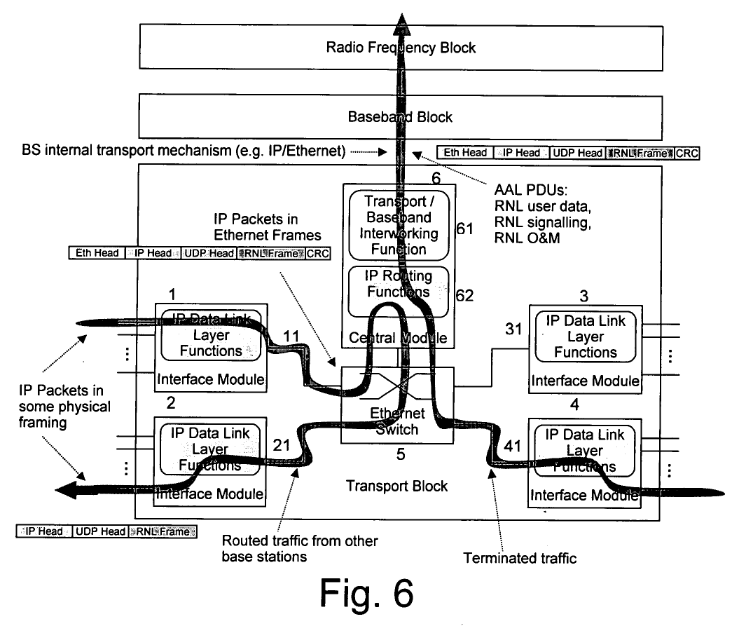

In the following, the architecture described above is described for the case that the transport block is configured for ATM and for the case that the transport block is configured for IP by referring to FIGS. 5 and 6.

FIG. 5 shows the transport block with software-defined exchangeable transport protocol architecture customized for ATM. That is, FIG. 5 shows the customisation of the arrangement depicted in FIG. 4 for Iub/ATM according to the present embodiment.

Standard ATM processing as checking of conformance to the traffic contract, CLP=1 tagging of non-conforming cells, OAM and RM cell handling etc. is done on the interface modules. Also ATM cross-connections are handled by the interface modules. AAL2 and AAL5 processing is done on the central module. This all is not described here in detail, since it is not relevant for the invention. Depending on the particular implementation, other partitioning of the ATM functionality is also feasible. All ATM-related functionality is realized in software. According to the present embodiment, it is assumed that the interface between TB and BB is based on IP protocols, so an inter-working function is provided which adapts the outer ATM world of the transport network to the inner IP world of the base station. Also this inter-working function is realized in software in the TB.

On the left side of the transport block, an ATM cross-connection is shown, which is provided by the interface modules 1 and 2. This ATM PVC (Permanent Virtual Circuit) may carry traffic from other base stations, which are physically connected to the depicted base station, in order to realize a RAN in chain or star topology. This traffic is only piped through the TB and not visible to the BB and RFB.

In detail, in this example the interface module 1 receives ATM cells comprising a VPI_in (incoming Virtual Path Identifier) (08 in this example) and a VCI_in (incoming Virtual Channel Identifier) (15 in this example), and comprises the cell payload (Cell PL). The ATM Layer Functions 11 of the interface module 1 encapsulates these ATM cells in Ethernet frames having an Ethernet header. In addition, VPI_out (outgoing Virtual Path Identifier) is set (in this example, to 47), and VCI_out (outgoing Virtual Channel Identifier) is set (in this example, to 11). The Ethernet switch 5 forwards these Ethernet frames to the interface module 2, which sends it via the PDH interface.

On the right side in FIG. 5, a terminated flow is shown. The ATM cells received by the interface modules (in this example, via interface module 4) are forwarded to the central module 6, which performs AAL processing thus reassembling the RNL frame. That is, the higher transport functions illustrated in FIG. 4 by block 62 are here represented by the AAL functions. The RNL frame is further processed by the inter-working function 61, which (according to the present embodiment) encapsulates the frame into IP packets and forwards the IP packet to the BB. After baseband processing, the frame is forwarded to the RFB and sent out over the air interface towards the mobile station. The other direction (from the mobile station towards the RAN) is similar, but not shown here.

Thus, as shown in FIG. 5 and described above, as an example, the Iub/ATM transport option can be loaded into the TB. The interface modules will then get software, which enables them to receive and transmit ATM cells in some physical framing. The interface modules can encapsulate ATM cells into Ethernet frames in order to forward the cells to another interface module (for ATM cross-connection) or to the central module (for traffic that is terminated in the base station). The central module implements AAL functions in order to reassemble (and segment in the other direction) radio network layer frames, which shall be forwarded to the BB. The inter-working function adapts then these frames to the format expected by the base-station internal interface between TB and BB. According to the present embodiment, this interface can be based on IP and Ethernet. The RNL frames are mapped to UDP messages or TCP streams in this case.

FIG. 6 illustrates a base-band block with software-defined exchangeable transport protocol architecture customized for IP. That is, FIG. 6 shows the customisation of the arrangement depicted in FIG. 4 for lub/IP. Standard IP data link layer processing is done on the interface modules. IP routing is done on the central module. This is not described here in detail, since it is not relevant for the invention. Depending on the particular implementation, other partitioning of the IP functionality is also feasible. All IP-related functionality is realized in software. Here, we assume that the interface between TB and BB is based on IP protocols, so we need only a null inter-working function.

On the left side, a routed flow (e.g. traffic from other base stations) is shown, and on the right side, a terminated IP flow is shown.

In detail, IP packets arrive at the interface module 1, and the lower transport function 11, now having software for performing IP data link layer functions, encapsulates the received IP packets into Ethernet frames. That is, the Ethernet frames comprise an Ehternet head, the IP head, a UDP (User Datagram Protocol) head, a RNL (Radio Network Layer) head and a CRC (Cyclic Redundancy Checksum). These Ethernet packets are forwarded by the Ethernet switch 5 to the Higher transport functions 62 of the central module 6, which now comprises software for IP routing functions. That is, in this example the routing is performed by the central module. The packets are then forwarded, via the Ethernet switch 5, to the interface module 2. The IP data link layer functions thereof convert the Ethernet encapsulation of the IP packets into another layer 2 encapsulation suitable for the external network, which is e.g. connecting to another base station.

In the example of terminated traffic, the interface module 4 receives IP packets destinated for the radio frequency block. The IP data link layer functions 41 encapsulate the received IP packets into Ethernet frames, similar as in the case of the routed traffic described above. These Ethernet frames are forwarded to the Ethernet switch 5, which forwards them to the IP Routing functions 62 of the central module. The IP Routing functions convert (e.g., extract) the Ethernet frames into IP packets (or packets of another protocol suitable for the radio frequency block) and forwards them to the transport/baseband interworking function 61 of the central module.

Thus, according to the arrangement shown in FIG. 6, the lub/IP transport option is be loaded into the TB. The interface modules will then get software, which enables them to receive and transmit IP packets in some physical framing. The interface modules can encapsulate IP packets into Ethernet frames in order to forward the packets to the central module. The central module implements IP routing functionality, and decides whether the IP packet shall be routed further on into the IP network, or the IP packet belongs to a traffic stream, which is terminated in the base station. If the IP packet shall be routed, it will be sent to an interface module; if the IP packet belongs to a terminated stream, it will be forwarded to the inter-working function. The inter-working function adapts then the RNL frames contained in the IP packets to the format expected by the base-station internal interface between TB and BB. According to the present embodiment, this interface can be also based on IP, as the whole RAN. In this case, the inter-working function can become a null function, and the TB is an IP router.

Hence, according to the present embodiment, the transport protocol used for the TB can easily be changed between IP and ATM by changing the software of the lower and higher transport functions. No exchange of hardware is required.

Thus, according to the present embodiment, the traffic to and from the outside of the transport block is converted into a form suitable for the switch 5. That is, internally the transport block operates with Ethernet frames which can be handled by the switch 5. The conversion between the Ethernet frames and the outside network protocol (e.g., IP or ATM) is fully handled via software in the lower transport functions 11, 21, 31 and 41. Likewise, the higher transport functions 62 of the central module convert the traffic received via the switch 5 into a protocol suitable for the higher functions of the transport block, for example, and vice versa. Thus, the internal Ethernet structure of the node forms a universal and never changing basis, on which several externally visible network protocols as ATM and IP can be realized just by providing the adequate software.

In the case of an operator-initiated change from Iub/ATM to lub/IP, the operator will load a new software package into the TB, using the normal housekeeping functions of the TB as remote configuration management and software download. If base station vendors want to use the same hardware platform for ATM and IP transport, they will customize the universal node platform by installing the appropriate embedded software in production.

The software update can be performed via the network so that no maintenance on location is required. For this, a specific program loader may be provided which loads the new software into the corresponding interface modules and the central module.

The software might be delivered as a software package containing suitable software binaries for each module type. Using the software management functionality of the node and of the network management system, the software package might be downloaded into the node via the remote management connection. The software management functions of the node might then distribute the contained software binaries to the corresponding modules. Along with the software package, a configuration file containing the required new settings of the node might be downloaded. The download successfully finished, the network management system might activate the new software package. Having received remotely the activation command, the node might then start the new software, e.g. by rebooting with the new binaries. After activation, the node might automatically apply the settings defined in the configuration file. With proper settings in the configuration file, the node (which might have operated as an ATM cross-connect before) might immediately perform its new role (e.g. IP router).

Hence, according to the present embodiment, a mobile operator can change the transport network from ATM to IP with pure software download, without changing hardware. Telecommunications equipment vendors can use exactly the same hardware platform for ATM and IP transport blocks and stand-alone transport nodes. The maintainability is increased, since a bug fix does not require the redesign and replacement of transport protocol-specific integrated circuits, but only a new software release. New features can be easily amended.

According to the first embodiment described above, an architecture was described comprising a central module and additional interface modules. But also an architecture is possible in which all functionality is located in a single module.

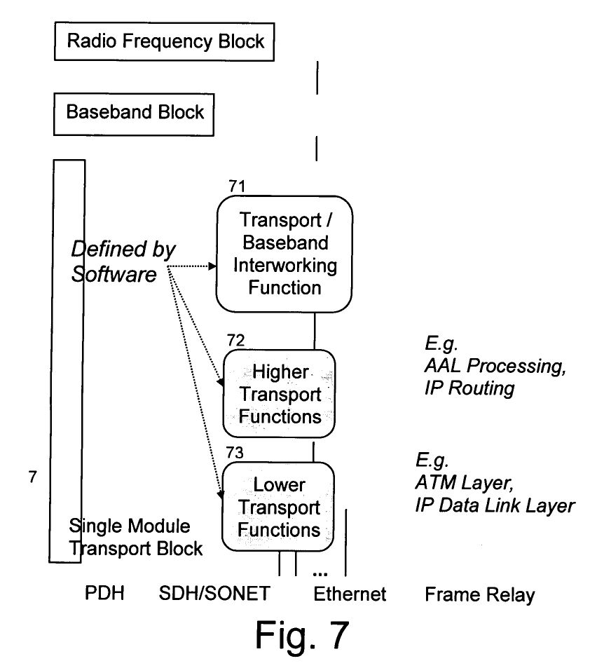

In the following, a second embodiment is described according to which a single module transport block 7 shown in FIG. 7 is provided. The single module comprises transport/baseband interworking function 71, higher transport functions 72 (e.g., AAL processing, IP routing), lower transport functions 73 (e.g., ATM layer, IP data link layer), which are all defined by software.

Thus, the transport block according to the second embodiment does not need a switch as according to the first embodiment.

Summarizing, according to the invention an implementation and mechanism (software upgrade) is provided in order to overcome the problem of needed hardware replacement when changing the transport protocol on the Iub interface in the WCDMA RAN from ATM to IP. A flexible base station hardware can support both ATM and IP transport protocols (e.g. by using network processors or FPGAs (Field Programmable Gate Arrays) in the implementation). Whether ATM or IP is used, is only determined by the embedded software of the transport block, and not by any hardware. This allows mobile operators in-field upgrade of the BTS from ATM to IP via remote software change, without the need of very expensive site visits and hardware replacements.

Thus, there are three main applications for the invention described above:
1. The transport block in a base station is upgraded from Iub/ATM to lub/IP via software download by the mobile operator.
2. A stand-alone ATM cross-connect/switch installed in a 3G network and needing to be turned into an IP router when the 3G network is upgraded from Iub/ATM to lub/IP. This is also done via SW download by the mobile operator.
3. Apart from these mobile applications: A general HW platform which can be used as ATM cross-connect/switch or IP router, depending on the burned-in firmware. A vendor will decide whether this HW is delivered as ATM cross-connect/switch or IP router, and the customer will never change it. This is advantageous for the vendor (not necessarily for the customer), since the same HW platform can be used for different products.

However, it is noted that the invention is not limited on these applications.

The above description and accompanying drawings only illustrate the present invention by way of example. Thus, the embodiment may vary within the scope of the attached claims.

For example, according to the embodiments described above, the network node is a base station. However, the invention is not limited thereon. By contrast, the network node according to the present invention can be any suitable network element or unit in which some transport functions are provided. For example, the network node my comprise standalone ATM cross-connects or switches which are needed at hub sites, for example. Furthermore, the network node may comprise an IP router.

That is, the ATM cross-connects or switches can be transformed into IP routers by remote software change, if the hardware is designed accordingly, as described above.

Moreover, the embodiments described above are directed to radio access networks. However, the present invention is also applicable to all telecommunication or data networks deploying ATM nodes or IP routers.

Further on, this invention is not limited to ATM or IP. By contrast, almost all reasonable transport protocol stacks can be realized with the same hardware platform with the proper software.

1. A network node comprising
at least one module including transport functions in order to support a particular network transport protocol, wherein the transport functions are realized by software.

2. The network node according to claim 1, wherein the network node comprises a plurality of modules and the modules further comprise at least one interface module.

3. The network node according to claim 1, wherein the network node comprises a plurality of modules and the modules further comprise a central module.

4. The network node according to claim 1, further comprising a node-internal network providing means for providing a connection for the at least one module.

5. The network node according to claim 4, wherein
the node-internal network providing means is configured to operate with a particular node-internal network transport protocol, and
the transport functions of the at least one module are configured to convert traffic according to the particular network transport protocol into a form suitable for the node-internal network transport protocol, and to receive the traffic from the node-internal network providing means and to convert traffic according to the node-internal network transport protocol received from the node-internal network providing means into the particular network transport protocol.

6. The network node according to claim 5, wherein the node-internal network transport protocol is an Ethernet protocol.

7. The network node according to claim 5, wherein the node-internal network providing means is a switch.

8. The network node according to claim 1, further comprising means for updating the software of the transport functions of the at least one module.

9. The network node according to claim 8, wherein the means for updating the software is configured to update the software remotely.

10. The network node according to claim 1, wherein the network transport protocol is Internet Protocol (IP).

11. The network node according to claim 1, wherein the network transport protocol is Asynchronous Transfer Mode (ATM).

12. The network node according to claim 1, wherein the network node is a base station.

13. A method for operating a network node, wherein the network node comprises at least one module including transport functions to support a particular network transport protocol, the method comprising the step of:
performing the transport functions by using software.

14. The method according to claim 13, wherein the said step of performing the transport functions comprises performing the transport functions supported by a plurality of modules, the modules comprising at least one interface module.

15. The method according to claim 13, wherein the said step of performing the transport functions comprises performing the transport functions supported by a plurality of modules, the modules comprising a central module.

16. The method according to claim 13, wherein the said step of performing the transport functions comprises performing the transport functions utilizing a node-internal network providing means for connecting to the at least one module.

17. The method according to claim 16, wherein the node-internal network providing means is configured to operate with a particular node-internal network transport protocol, the method further comprising the steps of:
converting traffic according to the particular network transport protocol into a form suitable for the node-internal network transport protocol by using the transport functions of the at least one module, and
converting traffic according to the node-internal network transport protocol received from the node-internal network providing means into the particular network transport protocol by using the transport functions of the at least one module.

18. The method according to claim 17, wherein the said steps of converting traffic are implemented according to an Ethernet protocol.

19. The method according to claim 17, wherein the said step of converting traffic according to the node-internal network transport protocol comprises converting traffic received from a switch.

20. The method according to claim 14, further comprising the step of:
updating the software of the transport functions of the at least one module.

21. The method according to claim 20, wherein the updating step is performed remotely.

22. The method according to claim 14, wherein the said step of performing the transport functions support the Internet Protocol (IP).

23. The method according to claim 14, wherein the said step of performing the transport functions support the Asynchronous Transfer Mode (ATM) protocol.

24. The method according to claim 14, wherein the said step of performing the transport functions comprises performing the transport functions within a base station.

25. A network node comprising: transport function providing means for providing transport functions to support a particular network transport protocol and means for performing the transport functions by using software.

26. A network node according to claim 25, wherein the transport function providing means utilizes a node-internal network providing means for connecting to the at least one module.

27. A network node according to claim 25, further comprising:
a first converting means for converting traffic according to the particular network transport protocol into a form suitable for the node-internal network transport protocol by using the transport functions of the at least one module; and
a second converting means for converting traffic according to the node-internal network transport protocol received from the node-internal network providing means into the particular network transport protocol by using the transport function of the at least one module.

28. A network node according to claim 27, wherein the first and second converting means are implemented according to an Ethernet protocol.

29. A network node according to claim 27, wherein the second converting means is configured to convert traffic received from a switch.

30. A network node according to claim 25, containing updating means for updating the software of the transport function of the at least one module.

31. A network node according to claim 30, wherein the updating means is configured to perform remotely.
